(19) United States
(12) Patent Application Publication
(10) Pub. No.: US 2013/0193827 A1
(43) Pub. Date: Aug. 1, 2013

(54) VERSCHLUSSELEMENT

(71) Applicant: Liebherr-Hausgerate Lienz GmbH, Lienz (AT)

(72) Inventors: Mohd Kamal MAHAT, Kluang (MY); Lip Keong KWAK, Klang (MY); Muhd Shuhail HASSAN, Kluang (MY); M. Noorashidi M. NASIR, Kluang (MY)

(73) Assignee: LIEBHERR-HAUSGERATE LIENZ GMBH, Lienz (AT)

(21) Appl. No.: 13/747,973

(22) Filed: Jan. 23, 2013

(30) Foreign Application Priority Data
Jan. 25, 2012 (DE) 102012001324.8
Feb. 15, 2012 (DE) 102012003004.5

(51) Int. Cl. E05B 65/00; E06B 7/28; F25D 23/02

(52) U.S. Cl. CPC E05B 65/0042; F25D 23/028; E06B 7/28
USPC 312/405; 49/503; 49/506

(57) ABSTRACT

The invention relates to a closure element, in particular to a cover or door, for a refrigerator unit and/or freezer unit, wherein the closure element has at least one blocking means or is connected thereto, which blocking means is movable into a release position and into a locked position, wherein the blocking means is arranged such that the closure element or a part of the closure element cannot be opened in the locked position of the blocking means, wherein at least one displaceably arranged covering is provided which is movable into different positions, and wherein the covering covers the blocking means or an opening leading to the blocking means in a first position and releases it for use in a second position.

The present invention relates to a closure element, in particular to a cover or to a door, for a refrigerator unit and/or freezer unit or of a refrigerator unit and/or freezer unit, in particular of a or for a chest refrigerator and/or a chest freezer, wherein the closure element has at least one blocking means or is connected to at least one blocking means which is movable into a release position and into a locked position, wherein the blocking means is arranged such that the closure element or a part of the closure element cannot be opened in the locked position of the blocking means.

It is known from the prior art to design chest refrigerators and/or chest freezers with a sliding cover, for example made from a glass or plastic surrounded by a frame, wherein this sliding cover is pushed to the side to allow the user access to the cooled inner space. If this is not required, the sliding cover closes the access region into the inner space so that as little heat as possible penetrates.

It is known from the prior art to design these sliding covers from a combination of a frame and one or more panes fixed in the frame, wherein the frame is arranged displaceable relative to the carcass of the appliance. A blocking means in the form of a latch can be provided in the frame which has the function of preventing an unwanted opening of the closure element. This can, for example, be achieved by a lock or by a key-activated lock which can be actuated by a key, and indeed such that it can be moved, for example by the store staff, into the release position or into the locked position and also into the release position.

It is furthermore known from the prior art to provide the opening of the keyhole of such a lock with a cap to prevent its contamination. This cap is either simply inserted into the keyhole and is fixed by friction grip. When it is removed, there is a risk that the cap is lost.

It is the underlying object of the present invention to further develop a closure element of the initially named kind such that it allows a simple and practical use.

This object is achieved by a closure element having the features of claim 1. Provision is accordingly made that at least one displaceably arranged covering is provided which can be moved into different positions, wherein the covering covers the blocking means or an opening of the blocking means, for example a keyhole, in a first position and releases it, i.e. makes it accessible, for use in a second position.

Provision is thus made in accordance with the invention that the covering is formed by a sliding element which releases the opening of the blocking means or the blocking means itself or also covers it depending on the sliding position. A comparatively simple covering possibility for the blocking mean is thereby ensured and the possibility is opened up always to leave the covering in the region of the blocking means, i.e. not to have to remove it when the blocking means has to be made accessible. It is sufficient simply to displace the covering.

The probability of the loss of the covering is thereby correspondingly reduced since it can remain at any location, i.e. at the closure element or at a part of the closure element, independently of its position. Apart from this, an extensive area around the blocking means is also covered by the covering, for example, so that the region of the covering can be designed in a visually appealing manner.

It is particularly advantageous when the cover is received in a guide in which it is movable to and fro. In this respect, the guide can be configured so that the covering cannot easily be removed, but rather only while exerting a force or while destroying the covering or the guide. This prevents the covering from being accidentally lost and ensures that the covering always remains in the region of the blocking means.

Provision is made in a further embodiment of the invention that the closure element has at least one frame and that the blocking means and/or the covering is arranged at least partly in or at the frame.

Provision can furthermore be made that the closure element has at least one frame and that the frame surrounds at least one pane, in particular at least one pane of glass or plastic, and in particular surrounds it in its marginal region.

One or more panes can be fixedly arranged in the frame so that the cooled inner space is visible even with a closed closure element. It is also conceivable that the at least one pane is movable, in particular displaceable or pivotable, relative to the frame. A preferred embodiment, however, comprises the pane(s) being fixedly arranged in the frame and the frame being displaced, pivoted, etc. together with the pane or panes for opening the appliance.

It is conceivable that the frame runs in one or more guides of the appliance carcass. These guides can be arranged so that they lie over one another so that a plurality of sliding covers or their frames or panes can be pushed over one another.

Provision is made in a further embodiment of the invention that the closure element has a recess or a region bounded by a web or the like into which region the covering is displaceably received. The recess or the region bounded by a web or by other means thus represents the movement region for the covering. The blocking means or its opening is located in this region and can be covered by the covering in at least one position of the covering so that the contamination tendency of the blocking means is correspondingly reduced and the overall visual impression is improved.

Provision is made in a further embodiment of the invention that the covering has a first region which covers the blocking means in a first position and has a second region which is arranged adjacent to the first region and which forms the actuation surface of the covering. To allow a simple actuation of the covering or its simple displacement, provision can be made that the actuating surface does not have a planar surface, but is either roughened or has one or more projections such as webs which preferably extend transversely or obliquely to the direction of movement of the covering.

Provision can furthermore be made that the blocking means is a lock whose keyhole is covered by the covering in its first position.

Provision is made in a further embodiment of the invention that the frame comprises a plurality of frame parts, wherein provision is preferably made that of two frame parts adjacent in the frame one has a projection and the other has a mount into which the projection is introduced and wherein the two named frame parts are connected to one another by the process of ultrasound welding.

The present invention further relates to a refrigerator unit and/or freezer unit having a closure element in accordance with one of the claims 1 to 9. Provision is preferable made that the unit is a chest refrigerator and/or chest freezer.

The invention further relates to a refrigerator unit and/or freezer unit, in particular a chest refrigerator and/or chest freezer, wherein the unit has at least one blocking means or is connected thereto, which blocking element is movable into a release position and into a locked position, wherein the blocking means is arranged and designed such that, the closure element of the unit or a part of this closure element which closes the cooled inner space of the unit in the closed state cannot be opened in the locked position of the blocking means, wherein at least one displaceably arranged covering is provided which is movable into different positions, wherein the covering covers the blocking means or an opening leading to the blocking means in a first position and releases it for use in a second position.

The blocking means can thus be arranged at the closure element, but also at any other point of the appliance, e.g. at or in the appliance carcass or a frame forming the upper termination of the appliance carcass. Guides can be arranged in this frame in which the closure element such as a sliding cover runs. These statements apply accordingly to the covering. It can also, but does not have to be arranged at the closure element. It is, for example, conceivable hat it is arranged at the carcass of the applications, such as at the named frame having the guides for the closure element.

The above-named features of the arrangement and embodiment of the covering and of the blocking means apply to all embodiments in which the covering and/or the blocking means is/are arranged at the closure element or also at any other position of the appliance, such as at the carcass, is is/are connected thereto.

It is conceivable that the blocking means is configured and arranged such that it prevents a movement of the closure element relative to the appliance carcass in the locked position or such that it prevents the movement of a part of the closure element, in particular of a pane, relative to another part of the closure element. It is thus conceivable that the blocking means prevents the movement of the closure element overall, such as the opening of a door or the pivoting of a cover.

It is conceivable that the closure element is designed as multipart such as from a frame and one or more panes movable relative to the frame and that the blocking means is configured such that it prevents the movement of at least two pants of the closure element relative to one another. It is, for example, conceivable that the blocking means is configured such that it prevents a displacing of the at least one pane of the closure element relative to the frame. In this case, a “closure element” is understood as the combination of frame and the at least one pane. It can also be prevented in this case that access to the inner space can be prevented by the blocking means since said inner space is not accessible in the locked position of the blocking means.

The present invention is not restricted to a chest refrigerator and/or chest freezer, but rather also includes other refrigerator units and/or units such as a refrigerator cabinet and/or freezer cabinet.

Further details and advantages of the invention will be explained in more detail with reference to an embodiment shown in the drawing. There are shown:

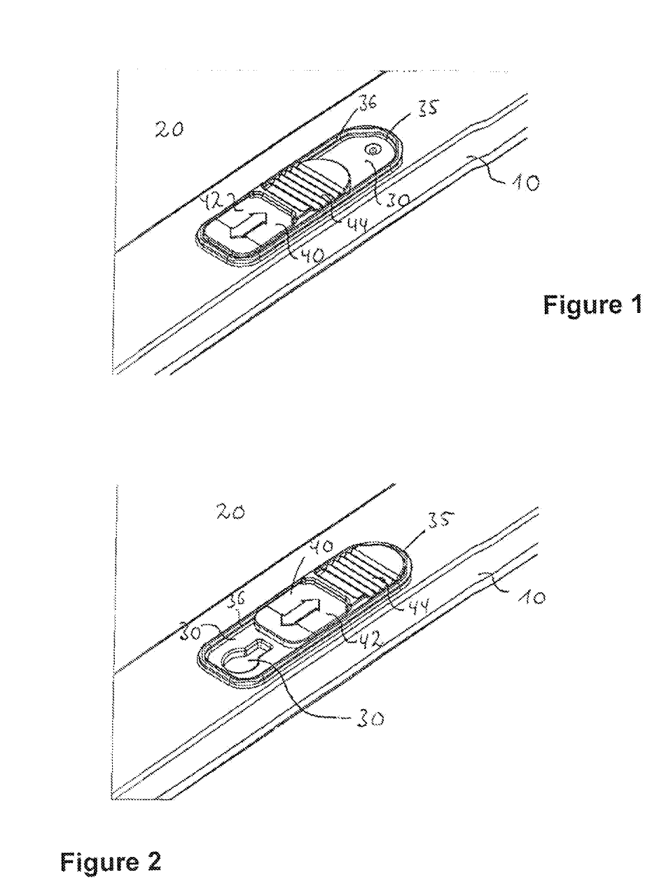

FIG. 1: a perspective representation of the frame of a chest refrigerator and/or chest freezer with a blocking means arranged at its upper side and with a covering in its first position; and

FIG. 2: a perspective representation of the frame of a chest refrigerator and/or chest freezer with a blocking means arranged at its upper side with a covering in its second position.

FIG. 1 shows with the reference numeral 10 a frame of a chest refrigerator and/or chest freezer which comprises metal or plastic, for example, and which is a component of a closure element, such as of a sliding cover. It is also conceivable that the frame is arranged in a fixed position and is, for example, placed at the top onto the carcass of the appliance or forms its upper termination.

The frame 10 is designed as peripheral and surrounds one or more panes such as panes of glass or plastic 20 which is/are designed fixed in the frame 10 or displaceable relative to the frame. If the user wants to reach into the cooled inner space, he displaces the closure element, comprising the frame 10 and the pane or panes 20, so that the cooled space is accessible.

The keyhole of a key-activated lock is marked by the reference numeral 30 in FIG. 2, with the key-activated lock having the function of fixing the frame and thus also the closure element relative to the appliance carcass, and indeed such that the frame cannot be moved in the locked position. In this case, the closure element thus remains closed and cannot be displaced or pivoted, etc. by a user. The key-activated lock thus represents a security against theft. The same applies accordingly to the embodiment in which the pane is movable relative to the frame or to the carcass. It is conceivable to configure the blocking means or the lock such that the pane cannot be moved relative to the frame or carcass when the blocking means is located in the locked position.

As can furthermore be seen from FIG. 2, the keyhole or the accessible region of the key-activated lock 20 is located in a region 30 on the upper side of the frame 10 with the region 30 being bounded by a peripheral web 35.

A covering 40 is arranged movable to and fro by guides 36 within the limited region 35.

This covering 40 has projections in its oppositely disposed lateral regions which are not shown in any more detail and which engage into the guides 36. It is thus possible to move the covering 40 to and fro within the region, but preferably not to take the covering 40 from this region, i.e. to remove it from the frame 10.

The covering 40 has a first region 42 which e.g. has a smooth surface and is marked by a double arrow. This region 42 serves to cover the keyhole in the first position of the covering 40 shown in FIG. 1. In this position, a visually appealing overall impression is thus ensured and a contamination of the keyhole or of the key-activated lock thereunder is precluded.

If the key-activated lock is to be actuated, the covering 40 is displaced into the position visible in FIG. 2 in which the section 42 of the covering 40 releases the keyhole, as can be seen from FIG. 2.

The region 44 of the covering 40 is located adjacent to the region 42. This region 44 has a fluted region which serves as an actuating surface of the covering 40. If the covering has to be displaced, for example from the first position shown in FIG. 1 into the second position shown in FIG. 2, the user displaces the covering 40 accordingly with his finger on the surface 44 and can then actuate the lock. He can subsequently push the covering 40 back into the position shown in FIG. 1.

Provision is made in a preferred embodiment of the invention that the covering 40 partly or fully comprises a heat-insulating material. This brings along the advantage that the heat passage through the region of the key-activated lock or through the region in which the covering 40 is arranged is correspondingly reduced and thus a “cold bridge” is avoided.

As stated above, the frame can form a component of a closure element such as of a sliding cover or can also be arranged in a fixed position and can form, for example, the upper boundary of the appliance carcass.

1. A closure element, in particular a cover or door, for a refrigerator unit and/or freezer unit or of a refrigerator unit and/or of a freezer unit, the closure element comprising at least one blocking means which is movable into a release position and into a locked position, wherein the blocking means is arranged and designed such that the closure element or a part of the closure element cannot be opened in the locked position of the blocking means, wherein at least one displareably arranged covering is provided which is movable into different positions, wherein the covering covers the blocking means or an opening leading to the blocking means in a first position and releases it for use in a second position.

2. A closure element in accordance with claim 1, wherein the covering is received in a guide and cannot be removed from the guide or can only be removed while exerting a force.

3. A closure element in accordance with claim 1, wherein the closure element has at least one frame; and in that the blocking means and/or the covering is arranged at least partly in or at the frame.

4. A closure element in accordance with claim 1, wherein the closure element has at least one frame; and in that the frame surrounds at least one pane, in particular at least one pane of glass or plastic, and in particular surrounds h in its marginal region.

5. A closure element in accordance with claim 1, wherein the closure element has a recess or a region bounded by a web or the like in which the covering is displaceably received.

6. A closure element in accordance with claim 1, wherein the covering has a first region which covers the blocking means or the opening leading to the blocking means in the first position and has a second region which is arranged adjacent to the first region and which forms the actuation surface of the cover.

7. A closure element in accordance with claim 6, wherein the actuation surface does not have any planar surface, but rather in that its surface is roughened and or has one or more projections, in particular webs.

8. A closure element in accordance with claim 1, wherein the blocking means is a lock whose keyhole is covered by the covering in his first position.

9. A closure element in accordance with claim 1, wherein the frame comprises a plurality of frame parts, wherein provision is preferably made that of two frame parts adjacent in the frame one has a projection and the other has a mount into which the projection is introduced and wherein the two named frame parts are connected to one another by the process of ultrasound welding.

10. A refrigerator unit and/or freezer unit, preferably a chest refrigerator or chest freezer, wherein the unit has at least one closure element in accordance with claim 1; and/or in that the unit has at least one blocking means or is connected to it which is movable into a release position and into a locked position, wherein the blocking means is arranged and designed such that the closure element or a part of the closure element cannot be opened in the locked position of the blocking means, wherein at least one displaceably arranged covering is provided which is movable into different positions, wherein the covering covers the blocking means or an opening leading to the blocking means in a first position and releases it for use in a second position.

11. A refrigerator unit and/or freezer unit in accordance with claim 10, wherein the blocking means is configured and arranged such that it prevents a movement of the closure element relative to the unit carcass in the locked position or such that it prevents the movement of a part of the closure element, in particular of a pane, relative to another part of the closure element.

12. A refrigerator unit and/or freezer unit in accordance with claim 1, wherein the refrigerator unit and/or freezer unit is a chest refrigerator or a chest freezer.
